(19) United States
(12) Patent Application Publication
(10) Pub. No.: US 2025/0293910 A1
(43) Pub. Date: Sep. 18, 2025

(54) SENSING SIGNAL TRANSMISSION METHOD AND RELATED APPARATUS

(71) Applicant: HUAWEI TECHNOLOGIES CO., LTD., Shenzhen (CN)

(72) Inventors: Xiaohui LI, Shenzhen (CN); Jiajin LUO, Shenzhen (CN)

(21) Appl. No.: 19/220,701

(22) Filed: May 28, 2025

Related U.S. Application Data
(63) Continuation of application No. PCT/CN2022/135507, filed on Nov. 30, 2022.

(51) Int. Cl. H04L 27/26; H04W 4/38; H04W 72/0446

(52) U.S. Cl. CPC H04L 27/26025; H04L 27/2605; H04W 4/38; H04W 72/0446

(57) ABSTRACT

Example sensing signal transmission methods and related apparatuses are provided. One example method includes determining, by a first apparatus, a first numerology indicating a length of a first time domain symbol that is in a first slot and that is for carrying a sensing signal. The first apparatus determines a second numerology, where the second numerology indicates a length of a second time domain symbol that is in the first slot and that is for carrying a communication signal, and the length of the first time domain symbol and the length of the second time domain symbol are in an integer multiple relationship. The first apparatus performs at least one of sending the sensing signal based on the first numerology, sending the communication signal based on the second numerology, receiving the sensing signal based on the first numerology, or receiving the communication signal based on the second numerology.

### CROSS-REFERENCE TO RELATED APPLICATIONS

This application is a continuation of International Application No. PCT/CN2022/135507, filed on Nov. 30, 2022, the disclosure of which is hereby incorporated by reference in its entirety.

### TECHNICAL FIELD

This application relates to the communication field, and in particular, to a sensing signal transmission method and a related apparatus.

### BACKGROUND

Integrated sensing and communications (ISAC) is one of feature functions to be integrated in a mobile cellular communication system. That is, a wireless network has a sensing function while performing communication interaction. The sensing function senses a target or an environment by analyzing reflected, direct, and scattered signals of a radio wave.

Currently, the target may be sensed by using a communication signal. In other words, the communication signal may be used for sensing the target, or may be used for communication between devices. A monostatic sensing scenario is used as an example. After a communication signal sent by a transceiver device passes through a target within a specific distance range, an echo signal is formed. The communication signal being sent and the echo signal may interfere with each other. For ease of description, the distance range is denoted as an interference range. In a known technology, if the interference range needs to be adjusted, transmission of the communication signal may be greatly affected.

Therefore, a method is expected to be provided, to flexibly adjust the interference range without affecting the transmission of the communication signal.

### SUMMARY

This application provides a sensing signal transmission method and a related apparatus, to flexibly adjust an interference range without affecting transmission of a communication signal.

According to a first aspect, this application provides a sensing signal transmission method. The method may be performed by a first apparatus, or may be performed by a part (such as a chip or a chip system) configured in the first apparatus, or may be implemented by a logical module or software that can implement all or some functions of the first apparatus. This is not limited in this application.

Optionally, the first apparatus may be, for example, a network device or a terminal device.

The method includes: determining a first numerology, where the first numerology indicates a length of a first time domain symbol that is in a first slot and that is for carrying a sensing signal; determining a second numerology, where the second numerology indicates a length of a second time domain symbol that is in the first slot and that is for carrying a communication signal, and the length of the first time domain symbol and the length of the second time domain symbol are in an integer multiple relationship; and performing at least one of the following: sending the sensing signal based on the first numerology; sending the communication signal based on the second numerology; receiving the sensing signal based on the first numerology; or receiving the communication signal based on the second numerology.

The length of the second time domain symbol does not include a length of a cyclic prefix (CP) corresponding to the second time domain symbol. The length of the first time domain symbol does not include a length of a CP and a length of a guard interval (GI) that correspond to the first time domain symbol.

In the foregoing technical solutions, the first apparatus may separately determine the first numerology indicating the length of the first time domain symbol carrying the sensing signal and the second numerology indicating the length of the second time domain symbol carrying the communication signal, and send or receive a corresponding signal based on a corresponding numerology. The sensing signal is for sensing, and the communication signal is for communication between devices. In other words, the first numerology and the second numerology may be different. The first apparatus may flexibly adjust the first numerology for sensing without changing the second numerology for communication, so that transmission of the communication signal is not affected. This helps ensure compatibility between the sensing signal and the communication signal.

With reference to the first aspect, in some possible implementations, the first numerology is determined based on a sensing range and a first mapping relationship, and the first mapping relationship indicates at least one correspondence between the first numerology and the sensing range.

For example, the first apparatus may determine the sensing range based on an actual requirement, and then determine, based on the first mapping relationship, the first numerology corresponding to the sensing range.

With reference to the first aspect, in some possible implementations, the length of the first time domain symbol is less than the length of the second time domain symbol.

In this application, a shorter length of a time domain symbol indicates a larger sensing range. The length of the first time domain symbol is less than the length of the second time domain symbol. Compared with a known technology in which the communication signal is used for sensing a target, this application can increase the sensing range, and helps sense the target within a shorter distance.

With reference to the first aspect, in some possible implementations, the method further includes: determining a GI corresponding to the length of the first time domain symbol, where a resource in the GI is not for carrying a signal.

The GI may also be referred to as wait time. This is not limited in this application.

It may be understood that, when the length of the first time domain symbol is less than the length of the second time domain symbol, the first apparatus determines the GI, so that it can be ensured, by using the GI, that the first time domain symbol and the second time domain symbol are aligned in time domain; and the resource in the GI is not for carrying the signal, which helps reduce interference between carriers and improve system performance.

With reference to the first aspect, in some possible implementations, the length of the GI+the length of the first time domain symbol=the length of the second time domain symbol; or the length of the GI+the length of the first time domain symbol=the length of the second time domain symbol+a length of a first CP, where the first CP is a CP corresponding to the second time domain symbol.

In a possible design, the length of the GI+the length of the first time domain symbol=the length of the second time domain symbol+the length of the first CP.

In this design, if the CP corresponding to the first time domain symbol is not added before the first time domain symbol, time domain symbol alignment may be ensured by adding the GI. In other words, the first time domain symbol and the second time domain symbol are aligned. In this way, it is convenient to directly generate the sensing signal by using an existing communication signal generation mechanism (for example, an orthogonal frequency division multiplexing (OFDM) mechanism).

In another possible design, the length of the GI+the length of the first time domain symbol=the length of the second time domain symbol.

In this design, if the CP corresponding to the first time domain symbol is added before the first time domain symbol, the CP and the GI that correspond to the first time domain symbol are added to ensure the time domain symbol alignment. The length of the GI+the length of the first time domain symbol+the length of the CP corresponding to the first time domain symbol=the length of the second time domain symbol+a length of the CP corresponding to the second time domain symbol. Because the length of the CP corresponding to the first time domain symbol=the length of the CP corresponding to the second time domain symbol, the length of the GI+the length of the first time domain symbol=the length of the second time domain symbol.

With reference to the first aspect, in some possible implementations, the length of the first time domain symbol is less than (R1+R2−d)/c, where R1 represents a shortest distance between a sending apparatus of the sensing signal and a target region sensed by the sensing signal, R2 represents a shortest distance between a receiving apparatus of the sensing signal and the target region, c represents a speed of light, and d is a distance between the sending apparatus and the receiving apparatus.

With reference to the first aspect, in some possible implementations, a second CP is added before the first time domain symbol, and the second CP is the CP corresponding to the first time domain symbol.

Optionally, a resource in the second CP may not carry a signal, that is, no signal may be sent in the second CP; or a resource in the second CP may carry the sensing signal. For example, a signal at a tail of the first time domain symbol is moved to a head of the first time domain symbol form the second CP, or a part of a signal at the head of the first time domain symbol is used as the CP. This is not limited in this application. It may be understood that, if a manner in which the resource in the second CP carries the sensing signal is used, for example, the signal at the tail of the first time domain symbol is moved to the head of the first time domain symbol to serve as the second CP, because a CP is usually added before a known second time domain symbol for communication, this manner helps ensure consistency with a known communication signal mechanism. In other words, this manner helps directly generate the sensing signal by using the known communication signal generation mechanism. In addition, compared with a manner in which the resource in the second CP does not carry the signal, this manner helps improve a signal-to-noise ratio.

With reference to the first aspect, in some possible implementations, the first apparatus is the network device, and the method further includes: sending first indication information, where the first indication information indicates a transmission direction of the sensing signal and the first time domain symbol for transmitting the sensing signal.

With reference to the first aspect, in some possible implementations, the first apparatus is the terminal device, and the method further includes: receiving first indication information, where the first indication information indicates a transmission direction of the sensing signal and the first time domain symbol for transmitting the sensing signal.

The network device may indicate, to the terminal device, a time domain resource for transmitting the sensing signal, where the time domain resource includes the transmission direction of the sensing signal and the first time domain symbol for transmitting the sensing signal.

In a possible design, the first indication information includes a first index, the first index corresponds to a first-type slot format, the first-type slot format indicates a transmission direction of a signal transmitted on each time domain symbol in one slot and a type of the signal transmitted on each time domain symbol, and the type includes the sensing signal or the communication signal.

In another possible design, the first indication information includes a second index and a third index, the second index corresponds to a second-type slot format, the second-type slot format indicates a transmission direction of a signal transmitted on each time domain symbol in one slot, the third index corresponds to a third-type slot format, the third-type slot format indicates a type of the signal transmitted on each time domain symbol in the slot, and the type includes the sensing signal or the communication signal.

With reference to the first aspect, in some possible implementations, the first apparatus is the network device, and the method further includes: sending second indication information, where the second indication information indicates the first numerology and the second numerology.

With reference to the first aspect, in some possible implementations, the first apparatus is the terminal device, and the method further includes: receiving second indication information, where the second indication information indicates the first numerology and the second numerology.

Optionally, the second indication information is carried in a radio resource control (RRC) message, or the second indication information is carried in downlink control information (DCI).

According to a second aspect, this application provides a communication apparatus, to implement the method according to any one of the first aspect or the possible implementations of the first aspect. The communication apparatus includes a corresponding unit configured to perform the foregoing method. The unit included in the communication apparatus may be implemented by software and/or hardware.

According to a third aspect, this application provides a communication apparatus. The communication apparatus includes a processor. The processor is configured to enable, by executing computer instructions and/or by using a logic circuit, the communication apparatus to perform the method according to any one of the first aspect or the possible implementations of the first aspect.

Optionally, the communication apparatus further includes a memory. The memory is configured to store the computer instructions and/or a configuration file of the logic circuit.

Optionally, the communication apparatus further includes a transceiver, configured to input and/or output a signal.

According to a fourth aspect, this application provides a computer-readable storage medium. The computer-readable storage medium stores a computer program or instructions. When the computer program or the instructions are executed, the method according to any one of the first aspect or the possible implementations of the first aspect is implemented.

According to a fifth aspect, this application provides a computer program product. The computer program product includes instructions. When the instructions are run, the method according to any one of the first aspect or the possible implementations of the first aspect is implemented.

According to a sixth aspect, this application provides a chip system. The chip system includes a processor, and may further include a memory, to implement the method according to any one of the first aspect or the possible implementations of the first aspect. The chip system may include a chip, or may include a chip and another discrete device.

According to a seventh aspect, this application provides a communication system. The communication system includes a terminal device and a network device.

It should be understood that the second aspect to the seventh aspect of this application correspond to the technical solutions of the first aspect of this application, and beneficial effects achieved by the aspects and the corresponding feasible implementations are similar. Details are not described again.

### BRIEF DESCRIPTION OF DRAWINGS

FIG. 1 is a diagram of interference ranges in different sensing scenarios according to an embodiment of this application;

FIG. 2 is a diagram of an application scenario of a method according to an embodiment of this application;

FIG. 3 is a schematic flowchart of a sensing signal transmission method according to an embodiment of this application;

FIG. 4 is another schematic flowchart of a sensing signal transmission method according to an embodiment of this application;

FIG. 5 is a diagram of frequency domain resource allocation according to an embodiment of this application;

FIG. 6 is a block diagram of a communication apparatus according to an embodiment of this application;

FIG. 7 is another block diagram of a communication apparatus according to an embodiment of this application;

FIG. 8 is a diagram of a structure of a network device according to an embodiment of this application; and

FIG. 9 is a diagram of a structure of a terminal device according to an embodiment of this application.

### DESCRIPTION OF EMBODIMENTS

The following describes the technical solutions of this application with reference to the accompanying drawings.

The technical solutions provided in this application may be applied to various communication systems. For example, the technical solutions may be applied to a cellular system related to the 3rd generation partnership project (3GPP): a 4th generation (4G) communication system, for example, a long term evolution (LTE) system, a 5th generation (5G) communication system, for example, a new radio (NR) system, and a communication system that is evolved after 5G, for example, a 6th generation (6G) communication system. The technical solutions may be further applied to a wireless fidelity (Wi-Fi) system and a communication system that supports integration of a plurality of wireless technologies. This is not limited in this application.

The following first describes network elements in some embodiments of this application: a network device and a terminal device. In this embodiment of this application, a first apparatus may be, for example, the network device or the terminal device.

In embodiments of this application, the network device may be any device that has a wireless transceiver function, and is configured to communicate with the terminal device or another network device, or may be a device that connects the terminal device to a wireless network. The network device may include various forms of base stations, for example, a macro base station, a micro base station (also referred to as a small cell), a relay station, an access point (AP), a device that implements a base station function in a communication system that is evolved after 5G, an access point in a Wi-Fi system, a transmission reception point (TRP), a transmission point (TP), a mobile switching center, and a device that functions as a base station in device-to-device (D2D) communication, an unscrewed aerial vehicle, vehicle-to-everything (V2X) communication, or machine-to-machine (M2M) communication, and may further include a central unit (CU) and a distributed unit (DU) in a cloud access network (C-RAN) system, and a network device in a non-terrestrial network (NTN) communication system. In other words, the network device may be deployed on a high-altitude platform or a satellite. A specific form of the network device is not limited in embodiments of this application.

The network device provides a service for a cell, and the terminal device communicates with the cell by using a transmission resource (for example, a frequency domain resource or a spectrum resource) allocated by the network device. The cell may belong to a macro base station (for example, a macro eNB or a macro gNB), or may belong to a base station corresponding to a small cell. The small cell herein may include a metro cell, a micro cell, a pico cell, a femto cell, or the like. These small cells have characteristics of small coverage and low transmit power, and are applicable to providing a high-speed data transmission service.

In embodiments of this application, the terminal device may also be referred to as user equipment (UE), an access terminal, a user unit, a user station, a mobile station, a remote station, a remote terminal, a mobile device, a user terminal, a terminal, a wireless communication device, a user agent, or a user apparatus. The terminal device may be a device that provides voice/data connectivity for a user, for example, a handheld device or a vehicle-mounted device that has a wireless connection function. Currently, some examples of the terminal devices may be: a mobile phone, a pad, a computer that has a wireless transceiver function (for example, a notebook computer or a palmtop computer), a mobile internet device (MID), customer-premises equipment (CPE), a smart point of sale (POS) machine, a virtual reality (VR) device, an augmented reality (AR) device, a wireless terminal in industrial control, a wireless terminal in self-driving, an automated guided vehicle (AGV), an uncrewed aerial vehicle, communication devices on vehicles and high-altitude aircraft, a wireless terminal in remote medical, a wireless terminal in a smart grid, a wireless terminal in transportation safety, a wireless terminal in a smart city, a wireless terminal (for example, an electronic lock, a smart speaker, or a smart refrigerator) in a smart home, a terminal device in an internet of things (IoT) system, a cellular phone, a cordless phone, a session initiation protocol (SIP) phone, a wireless local loop (WLL) station, a personal digital assistant (PDA), a handheld device that has a wireless communication function, a computing device or another processing device connected to a wireless modem, a vehicle-mounted device, a wearable device, a terminal device in a 5G network or a network that is evolved after 5G, or the like.

The wearable device may also be referred to as a wearable smart device, and is a general term for wearable devices such as glasses, gloves, watches, clothes, and shoes that are developed by applying wearable technologies to smart designs of daily wear. The wearable device is a portable device that can be directly worn on the body or integrated into clothes or an accessory of a user. The wearable device is not only a hardware device, but also implements a powerful function through software support, data exchange, and cloud interaction.

In addition, the terminal device may alternatively include a sensor such as a smart printer, a train detector, or a gas station, and main functions include: collecting data (for some terminal devices), receiving control information and downlink data of the network device, sending an electromagnetic wave, and transmitting uplink data to the network device.

It should be understood that specific forms of the network device and the terminal device are not limited in this application.

It should be further understood that, in embodiments of this application, an apparatus configured to implement a function of the terminal device may be the terminal device, or may be an apparatus that can support the terminal device in implementing the function, for example, a chip system. The apparatus may be mounted in the terminal device or used in combination with the terminal device. The chip system may include a chip, or may include a chip and another discrete device. In embodiments of this application, the apparatus configured to implement the function of the network device may be the network device, or may be an apparatus that can support the network device in implementing the function, for example, a chip system. The apparatus may be mounted in the network device or used in combination with the network device. The chip system may include a chip, or may include a chip and another discrete device.

Before the method provided in embodiments of this application is described, the following descriptions are first provided.

1. For ease of clearly describing the technical solutions in embodiments of this application, in embodiments of this application, terms such as “first” and “second” are used to distinguish between same items or similar items that have basically same functions and purposes. For example, first indication information and second indication information are merely used to distinguish between different indication information, and do not limit sequences of the first indication information and the second indication information. A person skilled in the art may understand that the terms such as “first” and “second” do not limit a quantity or an execution sequence, and the terms such as “first” and “second” do not indicate a definite difference.

2. In embodiments of this application, an expression “at least one of the following items (pieces)” or a similar expression means any combination of these items, including a single item (piece) or any combination of a plurality of items (pieces). For example, at least one of a, b, and c may indicate a, or b, or c, or a and b, or a and c, or b and c, or a, b, and c, where a, b, and c may be singular or plural. In this application, “/” represents “or”. The term “and/or” describes an association relationship for describing associated objects and indicates that three relationships may exist. For example, a and/or b may indicate the following three cases: Only a exists, both a and b exist, and only b exists.

3. In embodiments of this application, terms “include”, “have”, and any variants thereof are intended to cover non-exclusive inclusion. For example, a process, method, system, product, or device that includes a series of steps or units is not necessarily limited to those clearly listed steps or units, but may include other steps or units that are not explicitly listed or are inherent to the process, method, product, or device.

To better understand the method provided in embodiments of this application, the following briefly describes terms in this application.

1. Numerology: According to the 3GPP specification, the numerology may refer to a “subcarrier spacing type”. In LTE, there is only one type of subcarrier spacing (that is, 15 kilohertz (kHz)). Therefore, no specific term is required to represent the subcarrier spacing. However, in NR, there are several different types of subcarrier spacings. As shown in Table 1, the types of subcarrier spacings include: 15 kHz, 30 kHz, 60 kHz, 120 kHz, and 240 kHz. Each type of subcarrier spacing corresponds to an index μ of one numerology. For example, a numerology indicated by an index μ=0 includes a subcarrier spacing of 15 kHz, and a numerology indicated by an index μ=1 includes a subcarrier spacing of 30 kHz. For brevity, no enumeration is provided herein.

TABLE 1

| μ | Δf = 2^{μ} · 15 | CP |
|---|---|---|
| 0 | 15 kHz | Normal |
| 1 | 30 kHz | Normal |
| 2 | 60 kHz | Normal, extended |
| 3 | 120 kHz | Normal |
| 4 | 240 kHz | Normal |

2. Time domain symbol: Smallest unit of a time domain resource. A time length of one symbol is not limited in embodiments of this application. A length of one symbol may vary for different subcarrier spacings. In embodiments of this application, a length of a time domain symbol may be a reciprocal of a subcarrier spacing.

Types of the time domain symbol may include uplink, downlink, flexible, or the like. This is used as an example instead of a limitation. When the type of the time domain symbol is uplink, it indicates that uplink signal transmission may be performed on the symbol. The uplink signal is a signal whose transmission direction is uplink, for example, may be a signal sent by a terminal device to a network device. When the type of the time domain symbol is downlink, it indicates that downlink signal transmission may be performed on the symbol. The downlink signal is a signal whose transmission direction is downlink, for example, may be a signal sent by a network device to a terminal device. When the type of the time domain symbol is flexible, it indicates that a transmission direction of a corresponding signal on the symbol is not determined. In this case, with reference to a related definition or configuration, a flexible symbol may be used for transmission of an uplink signal, or may be used for transmission of a downlink signal. This is not limited in embodiments of this application.

In this application, uplink may be further subdivided into uplink sensing or uplink communication. The uplink sensing may be understood as that an uplink sensing signal may be transmitted on the symbol. The uplink sensing signal is a sensing signal whose transmission direction is uplink, for example, may be a sensing signal sent by the terminal device to the network device. The uplink communication may be understood as that an uplink communication signal may be transmitted on the symbol. The uplink communication signal is a communication signal whose transmission direction is uplink, for example, may be a communication signal sent by the terminal device to the network device. Similarly, downlink may be further subdivided into downlink sensing or downlink communication, and flexible may be further subdivided into flexible sensing or flexible communication. For understanding of the foregoing symbols, refer to the descriptions of the uplink sensing and the uplink communication. Details are not described herein again.

One slot may include 14 symbols, or one slot may include 12 symbols. An example in which one slot includes 14 symbols is used in this application. However, a quantity of symbols included in one slot is not limited in this application.

3. Sensing: Sensing means sensing a target object or sensing environment information (such as a status and an attribute) by analyzing reflected, direct, and scattered signals of a radio wave, and can implement functions such as imaging, environment reconstruction, ranging, positioning, speed measurement, detection, and identification.

4. Interference range: In a sensing process, there may be a problem of mutual interference between a radio signal being sent and an echo signal. For example, if a length difference between a line-of-sight path and a reflection path is less than a speed of light multiplied by a pulse width (Tₚᵤₗₛₑ), the radio signal being sent and the echo signal interfere with each other. In other words, interference occurs provided that the length difference between the line-of-sight path and the reflection path is within a range from 0 to the speed of light multiplied by the pulse width. Therefore, a distance range in which the interference exists is denoted as the interference range, and correspondingly, a range greater than the distance is denoted as a sensing range. The line-of-sight path means that a sent signal directly arrives at a receiving device without passing through a target, and the reflection path means that the sent signal passes through the target and then arrives at the receiving device.

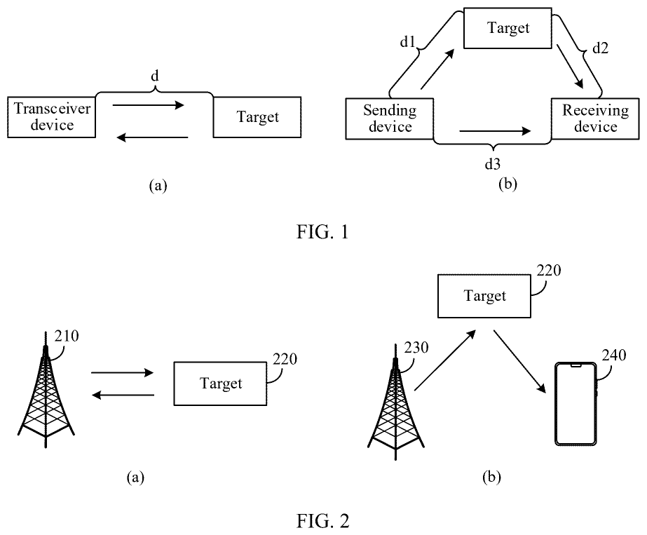

With reference to FIG. 1, the following separately describes the interference range in a monostatic sensing scenario and a bistatic sensing scenario. (a) in FIG. 1 shows the monostatic sensing scenario, that is, a device for sending a radio signal and a device for receiving a radio signal are a same device (which may be referred to as a “transceiver device”). (b) in FIG. 1 shows the bistatic sensing scenario. That is, a device for sending a radio signal and a device for receiving a radio signal are different devices (the device for sending a signal may be referred to as a “sending device”, and the device for receiving a signal may be referred to as a “receiving device”).

As shown in (a) in FIG. 1, in the monostatic sensing scenario, because the sending device and the receiving device are integrated, the line-of-sight path is 0, a distance from the sending device to the target is d, and a distance from the receiving device to the target is also d. Therefore, a length of a line-of-sight path is 2d. When 2d<cTₚᵤₗₛₑ, the radio signal being sent and the echo signal interfere with each other. Therefore, interference may occur provided that the target within a range of

$$\frac{1}{2} c {T}_{p u l s e}$$

from the transceiver device is sensed. For the monostatic sensing scenario, the interference range is

$$[ 0 , \frac{1}{2} c {T}_{p u l s e} ] ,$$

and correspondingly, the sensing range is

$$[ \frac{1}{2} c {T}_{p u l s e} , + ∞ ] .$$

c represents a speed of light.

As shown in (b) in FIG. 1, in the bistatic sensing scenario, a distance from the sending device to the target is d1, a distance from the receiving device to the target is also d2, and a length of the line-of-sight path is d3. When (d1+d2−d3)<cTₚᵤₗₛₑ, the radio signal being sent and the echo signal interfere with each other. c represents a speed of light.

5. Physical resource indication: Indicates allocation information of a time domain resource and a frequency domain resource. In this application, the physical resource indication mainly relates to an indication of the time domain resource and an indication of a numerology.

For example, the network device may indicate the time domain resource to the terminal device by using higher layer signaling. The higher layer signaling may be signaling sent from a higher-layer protocol layer. The higher-layer protocol layer is a protocol layer above a physical layer. The higher-layer protocol layer may include at least one of the following protocol layers: a MAC layer, a radio link control (RLC) layer, a packet data convergence protocol (PDCP) layer, an RRC layer, and a non-access stratum (NAS) layer. For example, in NR, the network device may indicate the time domain resource to the terminal device by using a slot format indicator (SFI) field carried in RRC layer signaling.

In another example, the network device may indicate the time domain resource to the terminal device by using DCI 2-0.

Table 2 shows an example of several types of slot formats. The slot format indicates a transmission direction of each symbol in one slot.

The network device may indicate one type of slot format to the terminal device by using RRC or DCI. For example, an index (for example, “0”) shown in Table 2 is carried in the RRC or the DCI. Correspondingly, the terminal device may perform uplink/downlink configuration for a single slot or a plurality of slots based on an indication of the network device.

TABLE 2

| | Slot format index | | | | | | | | | | | | | |
|---|---|---|---|---|---|---|---|---|---|---|---|---|---|---|
| | 1 | 2 | 3 | 4 | 5 | 6 | 7 | 8 | 9 | 10 | 11 | 12 | 13 | 14 |
| 0 | D | D | D | D | D | D | D | D | D | D | D | D | D | D |
| 1 | U | U | U | U | U | U | U | U | U | U | U | U | U | U |
| 2 | F | F | F | F | F | F | F | F | F | F | F | F | F | F |
| 3 | D | D | D | D | D | D | D | D | D | D | D | D | D | F |

It should be understood that Table 2 shows an example of several types of slot formats, but this should not constitute any limitation on this embodiment of this application. In another embodiment, more or fewer types of slot formats may be included.

The following describes in detail a sensing signal transmission method provided in embodiments of this application with reference to the accompanying drawings.

For ease of understanding embodiments of this application, the following first describes an application scenario applicable to the method provided in embodiments of this application. It may be understood that the application scenario described in embodiments of this application is intended to describe the technical solutions in embodiments of this application more clearly, and does not constitute a limitation on the technical solutions provided in embodiments of this application.

FIG. 2 is a diagram of an application scenario of a method according to an embodiment of this application.

As shown in (a) in FIG. 2, a transceiver device 210 (a network device is used as an example in the figure) may send a radio signal. The radio signal may be used for sensing a target 220. An echo signal generated after the radio signal sent by the transceiver device 210 passes through the target 220 arrives at the transceiver device 210. The transceiver device 210 may determine, based on the echo signal, existence of the target, a size of the target, and the like.

As shown in (b) in FIG. 2, a sending device 230 (a network device is used as an example in the figure) may send a radio signal. The radio signal may be used for sensing a target 220. An echo signal generated after the radio signal sent by the sending device 230 passes through the target 220 arrives at a receiving device 240 (a terminal device is used as an example in the figure). The receiving device 240 may determine, based on the echo signal, existence of the target, a size of the target, and the like.

It should be understood that the radio signal mentioned above may be used only for sensing a target, or may be used for communication simultaneously. This is not limited in this embodiment of this application.

It should be further understood that the transceiver device 210 shown in (a) in FIG. 2 may be a network device or a terminal device that has a transceiver function. A specific type of the transceiver device 210 is not limited in this application. The sending device 230 shown in (b) in FIG. 2 may be a network device or a terminal device that has a sending function, and the receiving device 240 shown in (b) in FIG. 2 may be a network device or a terminal device that has a receiving function. Specific types of the sending device and the receiving device are not limited in this application.

Currently, the target may be sensed by using a communication signal. In other words, the communication signal may be used for sensing the target, or may be used for communication between devices. The monostatic sensing scenario of shown in (a) in FIG. 2 is used as an example. In this process, there may be a problem of mutual interference between the communication signal being sent and the echo signal. In a known technology, if an interference range needs to be adjusted, sending of the communication signal may be greatly affected.

To flexibly adjust the interference range without affecting transmission of the communication signal, this application provides a sensing signal transmission method. A first apparatus may separately determine a first numerology indicating a length of a first time domain symbol carrying a sensing signal and a second numerology indicating a length of a second time domain symbol carrying a communication signal, and send or receive a corresponding signal based on a corresponding numerology. In other words, the first numerology for sensing and the second numerology for communication may be different. The first apparatus may flexibly adjust the first numerology for sensing without changing the second numerology for communication, so that transmission of the communication signal is not affected. This helps ensure compatibility between the sensing signal and the communication signal.

The following describes in detail the sensing signal transmission method provided in embodiments of this application with reference to the accompanying drawings.

It should be understood that the following embodiments describe the method from a perspective of the first apparatus, but should not constitute any limitation on an execution body of the method. The method provided in embodiments of this application can be performed, provided that a computer program that records the method provided in embodiments of this application can be run. For example, the first apparatus may alternatively be replaced with a part (for example, a chip or a chip system) configured in the first apparatus, or another functional module that can invoke a program and execute the program. This is not limited in this embodiment of this application. The first apparatus may be, for example, the transceiver device 210 shown in (a) in FIG. 2, the sending device 230 shown in (b) in FIG. 2, or the receiving device 240 shown in (b) in FIG. 2. This is not limited in this application.

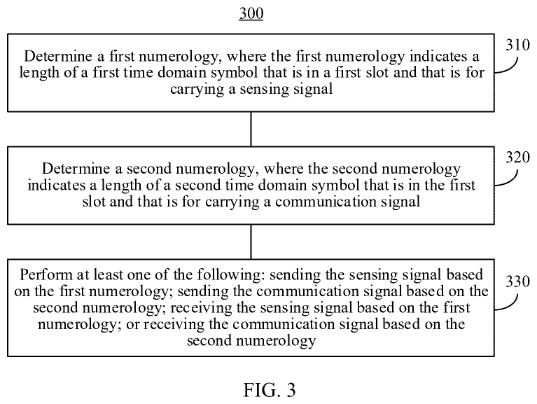

FIG. 3 is a schematic flowchart of a sensing signal transmission method 300 according to an embodiment of this application. The method 300 shown in FIG. 3 may include step 310 to step 330. The following describes in detail the steps in the method 300.

Step 310: Determine a first numerology, where the first numerology indicates a length of a first time domain symbol that is in a first slot and that is for carrying a sensing signal.

The sensing signal is for sensing a target, the first numerology indicates the length of the first time domain symbol that is in the first slot and that is for carrying the sensing signal, and the first slot is any slot. The first time domain symbol may be, for example, denoted as a sensing symbol. The length of the first time domain symbol neither includes a length of a GI nor includes a length of a CP corresponding to the first time domain symbol. In this application, the length of the first time domain symbol may also be denoted as a pulse width.

In a possible implementation, the first apparatus determines the first numerology based on a sensing range and a first mapping relationship, and the first mapping relationship indicates at least one correspondence between the first numerology and the sensing range. For example, the first apparatus may first determine an expected sensing range, and determine, based on the first mapping relationship, a first numerology corresponding to the sensing range. If the length of the first time domain symbol is less than a length of a second time domain symbol, the first time domain symbol and the second time domain symbol may be further aligned. For example, time domain symbol alignment may be ensured by using the GI. If the length of the first time domain symbol is greater than a length of a second time domain symbol, the second time domain symbol may be directly modulated by using an existing OFDM mechanism.

In another possible implementation, the first apparatus determines the first numerology based on indication information. For example, in a bistatic sensing scenario, a network device may determine the first numerology based on the sensing range and the first mapping relationship. Further, the network device indicates the first numerology to a terminal device, and the terminal device sends or receives the sensing signal based on the first numerology indicated by the network device.

Optionally, the length of the first time domain symbol is less than (R1+R2−d)/c. R1 represents a shortest distance between a sending apparatus of the sensing signal and a target region sensed by the sensing signal, R2 represents a shortest distance between a receiving apparatus of the sensing signal and the target region, c represents a speed of light, and d represents a distance between the sending apparatus and the receiving apparatus.

It can be learned from the foregoing explanation of the interference range that, if (R1+R2−d)<c*pulse width (the pulse width is the length of the first time domain symbol), the sensing signal being sent and an echo signal interfere with each other. Therefore, the length of the first time domain symbol should be less than (R1+R2−d)/c, to more accurately sense the target.

Step 320: Determine a second numerology, where the second numerology indicates the length of the second time domain symbol that is in the first slot and that is for carrying a communication signal.

The communication signal is for communication, and the second numerology indicates the length of the second time domain symbol that is in the first slot and that is for carrying the communication signal. For example, the second time domain symbol may be denoted as a communication symbol. In this embodiment of this application, the length of the second time domain symbol does not include a length of a CP corresponding to the second time domain symbol.

The length of the first time domain symbol and the length of the second time domain symbol are in an integer multiple relationship. For example, the length of the first time domain symbol is 2ⁿ times the length of the second time domain symbol. For another example, the length of the second time domain symbol is 2ⁿ times the length of the first time domain symbol. n is a positive integer. The length of the first time domain symbol and the length of the second time domain symbol are in an integer multiple relationship, so that the second time domain symbol may be directly generated by using an existing OFDM modulation method. It can be learned from the foregoing description that, in this application, the sensing signal and the communication signal in the first slot use different numerologies. A numerology table for sensing and a numerology table for communication include the following possible designs.

Design 1: Based on an existing numerology table (as shown in Table 1) for communication signal transmission, a numerology table (as shown in Table 3, Table 4, or Table 5) for sensing signal transmission is newly defined. The numerology table indicates an index of at least one numerology and a numerology corresponding to the index (for example, the length of the first time domain symbol). The length of the first time domain symbol in the table of the first numerology shown in Table 3 is defined by using a physical time length. The length of the first time domain symbol in the table of the first numerology shown in Table 4 is defined by using a quantity of sampling points. The length of the first time domain symbol in the table of the first numerology shown in Table 5 is defined by using a numerology corresponding to the communication signal.

In the tables shown in Table 3 to Table 5, μₛ shows possible values of an index of the first numerology, for example, 0 to 13 shown in Table 3. Tₚᵤₗₛₑ^{μ} is the length of the first time domain symbol for carrying the sensing signal. The length of the first time domain symbol neither includes the length of the CP corresponding to the first time domain symbol nor includes the length of the GI. The length of the first time domain symbol is equal to a reciprocal of a subcarrier spacing. T_{sym}^{μ}, is the length of the second time domain symbol plus the length of the CP corresponding to the second time domain symbol.

TABLE 3

| μₛ | Tₚᵤₗₛₑ^{μ}^{ₛ} = 2^{-μ}^{ₛ}/15 | | Length of a GI |
|---|---|---|---|
| 0 | 66.7 | μs | T_{sym}^{μ}^{_{c}} − Tₚᵤₗₛₑ^{μ}^{ₛ}⁼⁰ |
| 1 | 33.3 | μs | T_{sym}^{μ}^{_{c}} − Tₚᵤₗₛₑ^{μ}^{ₛ}⁼¹ |
| 2 | 16.7 | μs | T_{sym}^{μ}^{_{c}} − Tₚᵤₗₛₑ^{μ}^{ₛ}⁼² |
| 3 | 8.33 | μs | T_{sym}^{μ}^{_{c}} − Tₚᵤₗₛₑ^{μ}^{ₛ}⁼³ |
| 4 | 4.17 | μs | T_{sym}^{μ}^{_{c}} − Tₚᵤₗₛₑ^{μ}^{ₛ}⁼⁴ |
| 5 | 2.08 | μs | T_{sym}^{μ}^{_{c}} − Tₚᵤₗₛₑ^{μ}^{ₛ}⁼⁵ |
| 6 | 1.04 | μs | T_{sym}^{μ}^{_{c}} − Tₚᵤₗₛₑ^{μ}^{ₛ}⁼⁶ |
| 7 | 0.521 | μs | T_{sym}^{μ}^{_{c}} − Tₚᵤₗₛₑ^{μ}^{ₛ}⁼⁷ |
| 8 | 0.260 | μs | T_{sym}^{μ}^{_{c}} − Tₚᵤₗₛₑ^{μ}^{ₛ}⁼⁸ |
| 9 | 0.130 | μs | T_{sym}^{μ}^{_{c}} − Tₚᵤₗₛₑ^{μ}^{ₛ}⁼⁹ |
| 10 | 65.1e⁻³ | ns | T_{sym}^{μ}^{_{c}} − Tₚᵤₗₛₑ^{μ}^{ₛ}⁼¹⁰ |
| 11 | 32.6e⁻³ | ns | T_{sym}^{μ}^{_{c}} − Tₚᵤₗₛₑ^{μ}^{ₛ}⁼¹¹ |
| 12 | 16.3e⁻³ | ns | T_{sym}^{μ}^{_{c}} − Tₚᵤₗₛₑ^{μ}^{ₛ}⁼¹² |
| 13 | 8.14e⁻³ | ns | T_{sym}^{μ}^{_{c}} − Tₚᵤₗₛₑ^{μ}^{ₛ}⁼¹³ |

As shown in Table 3, the table of the first numerology includes a plurality of possible values of the index of the first numerology, the length of the first time domain symbols corresponding to the index, and the GI corresponding to the first time domain symbol. For example, when the value of the index of the first numerology is 0, the length of the first time domain symbol is 66.7 microseconds (ms), and the length of the GI corresponding to the first time domain symbol is T_{sym}^{μ}^{_{c}}−Tₚᵤₗₛₑ^{μ}^{ₛ}⁼⁰. For another example, when the value of the index of the first numerology is 13, the length of the first time domain symbol is 8.14 e⁻³ nanoseconds (ns), and the length of the GI corresponding to the first time domain symbol is T_{sym}^{μ}^{_{c}}−Tₚᵤₗₛₑ^{μ}^{ₛ}⁼¹³.

It should be understood that the length of the GI shown in Table 3 is a length of the GI when the CP corresponding to the first time domain symbol is not added before the first time domain symbol. As shown in Table 3, when the value of the index of the first numerology is k, a length of a corresponding GI is equal to T_{sym}^{μ}^{_{c}}−Tₚᵤₗₛₑ^{μ}^{ₛ}^{=k}. A value of k is 0 to 13. In other words, the length of the GI=the length of the second time domain symbol+the length of the CP corresponding to the second time domain symbol−the length of the first time domain symbol. When the CP corresponding to the first time domain symbol is added before the first time domain symbol, the length of the GI+the length of the first time domain symbol+the length of the CP corresponding to the first time domain symbol=the length of the second time domain symbol+the length of the CP corresponding to the second time domain symbol. The length of the CP corresponding to the first time domain symbol is equal to the length of the CP corresponding to the second time domain symbol. Therefore, the length of the GI=the length of the second time domain symbol−the length of the first time domain symbol. A resource in the GI may not carry a signal, that is, 0 is padded in time domain.

Optionally, a resource in the CP corresponding to the first time domain symbol may not carry a signal, that is, no signal may be sent in a second CP; or a resource in the CP corresponding to the first time domain symbol may carry the sensing signal. For example, a signal at a tail of the first time domain symbol is moved to a head of the first time domain symbol to form the CP corresponding to the first time domain symbol.

It should be further understood that content included in the table of the first numerology shown in Table 3 is merely an example, and should not constitute any limitation on this embodiment of this application. In another embodiment, more or less content may be included. For example, the table shown in Table 3 may not include a GI column, and a correspondence between the index of the first numerology and the GI is separately defined.

TABLE 4

| μₛ | Tₚᵤₗₛₑ^{μ}^{ₛ} = 2048 · κ · 2^{-μ}^{ₛ} [Tc] | Length of a GI |
|---|---|---|
| 0 | 131072 | T_{sym}^{μ}^{_{c}} − Tₚᵤₗₛₑ^{μ}^{ₛ}⁼⁰ |
| 1 | 65536 | T_{sym}^{μ}^{_{c}} − Tₚᵤₗₛₑ^{μ}^{ₛ}⁼¹ |
| 2 | 32768 | T_{sym}^{μ}^{_{c}} − Tₚᵤₗₛₑ^{μ}^{ₛ}⁼² |
| 3 | 16384 | T_{sym}^{μ}^{_{c}} − Tₚᵤₗₛₑ^{μ}^{ₛ}⁼³ |
| 4 | 8192 | T_{sym}^{μ}^{_{c}} − Tₚᵤₗₛₑ^{μ}^{ₛ}⁼⁴ |
| 5 | 4096 | T_{sym}^{μ}^{_{c}} − Tₚᵤₗₛₑ^{μ}^{ₛ}⁼⁵ |
| 6 | 2048 | T_{sym}^{μ}^{_{c}} − Tₚᵤₗₛₑ^{μ}^{ₛ}⁼⁶ |
| 7 | 1024 | T_{sym}^{μ}^{_{c}} − Tₚᵤₗₛₑ^{μ}^{ₛ}⁼⁷ |
| 8 | 512 | T_{sym}^{μ}^{_{c}} − Tₚᵤₗₛₑ^{μ}^{ₛ}⁼⁸ |
| 9 | 256 | T_{sym}^{μ}^{_{c}} − Tₚᵤₗₛₑ^{μ}^{ₛ}⁼⁹ |
| 10 | 128 | T_{sym}^{μ}^{_{c}} − Tₚᵤₗₛₑ^{μ}^{ₛ}⁼¹⁰ |
| 11 | 64 | T_{sym}^{μ}^{_{c}} − Tₚᵤₗₛₑ^{μ}^{ₛ}⁼¹¹ |
| 12 | 32 | T_{sym}^{μ}^{_{c}} − Tₚᵤₗₛₑ^{μ}^{ₛ}⁼¹² |
| 13 | 16 | T_{sym}^{μ}^{_{c}} − Tₚᵤₗₛₑ^{μ}^{ₛ}⁼¹³ |

It can be learned that, different from Table 3, the length of the first time domain symbol in Table 3 is defined by using the time length, and the length of the first time domain symbol in Table 4 is defined by using the quantity of sampling points.

TABLE 5

| μₛ | Tₚᵤₗₛₑ^{μ}^{ₛ} = 2^{-μ}^{ₛ}/15 | Length of a GI |
|---|---|---|
| 0 | T_{sym}^{μ}^{_{c}}⁼⁰ | T_{sym}^{μ}^{_{c}} − Tₚᵤₗₛₑ^{μ}^{ₛ}⁼⁰ |
| 1 | T_{sym}^{μ}^{_{c}}⁼¹ | T_{sym}^{μ}^{_{c}} − Tₚᵤₗₛₑ^{μ}^{ₛ}⁼¹ |
| 2 | T_{sym}^{μ}^{_{c}}⁼² | T_{sym}^{μ}^{_{c}} − Tₚᵤₗₛₑ^{μ}^{ₛ}⁼² |
| 3 | T_{sym}^{μ}^{_{c}}⁼³ | T_{sym}^{μ}^{_{c}} − Tₚᵤₗₛₑ^{μ}^{ₛ}⁼³ |
| 4 | T_{sym}^{μ}^{_{c}}⁼⁴ | T_{sym}^{μ}^{_{c}} − Tₚᵤₗₛₑ^{μ}^{ₛ}⁼⁴ |
| 5 | T_{sym}^{μ}^{_{c}}⁼⁵ | T_{sym}^{μ}^{_{c}} − Tₚᵤₗₛₑ^{μ}^{ₛ}⁼⁵ |
| 6 | T_{sym}^{μ}^{_{c}}⁼⁶ | T_{sym}^{μ}^{_{c}} − Tₚᵤₗₛₑ^{μ}^{ₛ}⁼⁶ |
| 7 | T_{sym}^{μ}^{_{c}}⁼⁷ | T_{sym}^{μ}^{_{c}} − Tₚᵤₗₛₑ^{μ}^{ₛ}⁼⁷ |
| 8 | T_{sym}^{μ}^{_{c}}⁼⁸ | T_{sym}^{μ}^{_{c}} − Tₚᵤₗₛₑ^{μ}^{ₛ}⁼⁸ |
| 9 | T_{sym}^{μ}^{_{c}}⁼⁹ | T_{sym}^{μ}^{_{c}} − Tₚᵤₗₛₑ^{μ}^{ₛ}⁼⁹ |
| 10 | T_{sym}^{μ}^{_{c}}⁼¹⁰ | T_{sym}^{μ}^{_{c}} − Tₚᵤₗₛₑ^{μ}^{ₛ}⁼¹⁰ |
| 11 | T_{sym}^{μ}^{_{c}}⁼¹¹ | T_{sym}^{μ}^{_{c}} − Tₚᵤₗₛₑ^{μ}^{ₛ}⁼¹¹ |
| 12 | T_{sym}^{μ}^{_{c}}⁼¹² | T_{sym}^{μ}^{_{c}} − Tₚᵤₗₛₑ^{μ}^{ₛ}⁼¹² |
| 13 | T_{sym}^{μ}^{_{c}}⁼¹³ | T_{sym}^{μ}^{_{c}} − Tₚᵤₗₛₑ^{μ}^{ₛ}⁼¹³ |

As shown in Table 5, the length of the first time domain symbol in the foregoing table is defined by using the numerology corresponding to the communication signal. For example, when the value of the index of the first numerology is 0, the length of the first time domain symbol is T_{sym}^{μ}^{_{c}}⁼⁰.

It should be understood that the numerology tables shown in Table 3 to Table 5 are merely examples, and should not constitute any limitation on this embodiment of this application. For example, in another embodiment, in a newly defined table of numerologies for sensing signal transmission, the length of the first time domain symbol may be further indicated by using the subcarrier spacing. This is not limited in this embodiment of this application.

Design 2: The numerology for communication signal transmission and the numerology for sensing signal transmission share one numerology table (as shown in Table 6). It should be noted that the first numerology and the second numerology may correspond to parameters corresponding to different μ in Table 6.

TABLE 6

| | | |
|---|---|---|
| μ | Δf = 2^{μ} · 15 | T_{sym} |

| | | | | |
|---|---|---|---|---|
| 0 | 15 | kHz | 71.35 | μs |
| 1 | 30 | kHz | 35.68 | μs |
| 2 | 60 | kHz | 17.84 | μs |
| 3 | 120 | kHz | 8.92 | μs |
| 4 | 240 | kHz | 4.46 | μs |
| 5 | 480 | kHz | 2.23 | μs |
| 6 | 960 | kHz | 1.12 | μs |
| 7 | 1.92 | MHz (MHz) | 557.50 | ns |
| 8 | 3.84 | MHz | 278.75 | ns |
| 9 | 7.68 | MHz | 139.38 | ns |
| 10 | 15.36 | MHz | 69.69e⁻³ | ns |
| 11 | 30.72 | MHz | 34.85e⁻³ | ns |
| 12 | 61.44 | MHz | 17.42e⁻³ | ns |
| 13 | 122.88 | MHz | 8.71e⁻³ | ns |

Table 7 is an example of the first mapping relationship provided in this embodiment of this application. As shown in Table 7, the first mapping relationship indicates indexes of a plurality of first numerologies and sensing ranges corresponding to the indexes. μₛ represents an index corresponding to the first numerology. In a monostatic sensing scenario, a lower limit of the sensing range=2R, where R represents a shortest distance between the first apparatus and the target region sensed by the sensing signal. In a scenario of one sensing device and one receiving device, a lower limit of the sensing range=R1+R2−d, where R1 represents a shortest distance between the sending apparatus and the target region sensed by the sensing signal, R2 represents a shortest distance between the receiving apparatus and the target region, and d represents the distance between the sending apparatus and the receiving apparatus. For example, if a region beyond 20 kilometers (kin) is expected to be sensed, μₛ=0. For another example, if a region [2.44 meters (in), 4.88 m) is expected to be sensed, μₛ=13.

TABLE 7

| μₛ | Sensing range |
|---|---|
| 0 | [20 km, +∞) |
| 1 | [10 km, 20 km) |
| 2 | [5 km, 10 km) |
| 3 | [2.5 km, 5 km) |
| 4 | [1.25 km, 2.5 km) |
| 5 | [625 m, 1.25 km) |
| 6 | [312.5 m, 625 m) |
| 7 | [156.25 m, 312.5 m) |
| 8 | [78.13 m, 156.25 m) |
| 9 | [39.06 m, 78.13 m) |
| 10 | [19.53 m, 39.06 m) |
| 11 | [9.77 m, 19.53 m) |
| 12 | [4.88 m, 9.77 m) |
| 13 | [2.44 m, 4.88 m) |

It should be understood that a correspondence between the index of the first numerology and the sensing range corresponding to the index shown in Table 7 is not limited to being in a form of a table, and may alternatively be in another data structure, for example, an array, a queue, or a stack. The foregoing form is not specifically limited in this embodiment of this application.

The first apparatus may select a corresponding sensing range based on an actual requirement, to determine a numerology corresponding to the sensing range.

It should be further understood that the sensing range corresponding to the index of the first numerology shown in Table 7 is merely an example, and should not constitute any limitation on this embodiment of this application. For example, in another embodiment, a boundary of the sensing range may alternatively be an approximate value or the like, for example, [10 km, +∞), [1 km, 10 km), [100 m, 1 km), and [10 m, 100 m). This is not limited in this application.

Step 330: Perform at least one of the following: sending the sensing signal based on the first numerology; sending the communication signal based on the second numerology; receiving the sensing signal based on the first numerology; or receiving the communication signal based on the second numerology.

In the monostatic sensing scenario, the first apparatus may perform the following steps:
sending the sensing signal based on the first numerology; receiving the sensing signal based on the first numerology; sending the communication signal based on the second numerology; and receiving the communication signal based on the second numerology. It may be understood that although the first apparatus determines the second numerology, the first apparatus may not send nor receive the communication signal, or although the first apparatus determines the first numerology, the first apparatus may not send nor receive the sensing signal. This is not limited in this embodiment of this application.

In the bistatic sensing scenario, the first apparatus is used as a sending end of the sensing signal, and the first apparatus may send the sensing signal based on the first numerology, and send the communication signal based on the second numerology. It may be understood that although the first apparatus determines the second numerology, the first apparatus may not send the communication signal, or although the first apparatus determines the first numerology, the first apparatus may not send nor receive the sensing signal. This is not limited in this embodiment of this application.

In the bistatic sensing scenario, the first apparatus is used as a receiving end of the sensing signal, and the first apparatus may receive the sensing signal based on the first numerology, and receive the communication signal based on the second numerology. It may be understood that although the first apparatus determines the second numerology, the first apparatus may not receive the communication signal, or although the first apparatus determines the first numerology, the first apparatus may not send nor receive the sensing signal. This is not limited in this embodiment of this application.

It may be understood that, in a scenario of self-sending and self-receiving (that is, the monostatic sensing scenario), if the transceiver device is the terminal device, the network device may indicate, to the terminal device, a transmission direction of the sensing signal and the first time domain symbol for transmitting the sensing signal. In the bistatic sensing scenario, for example, the network device sends the sensing signal, and the terminal device receives an echo signal of the sensing signal. For another example, the terminal device sends the sensing signal, the network device receives an echo signal of the sensing signal. The network device needs to indicate, to the terminal device, the transmission direction of the sensing signal and the first time domain symbol for transmitting the sensing signal.

In addition, in this application, receiving the sensing signal by the network device/terminal device may be understood as receiving the echo signal of the sensing signal. The echo signal of the sensing signal is an echo signal generated after the sensing signal passes through the target.

Optionally, the network device sends first indication information to the terminal device, where the first indication information indicates the transmission direction of the sensing signal and the first time domain symbol for transmitting the sensing signal. Correspondingly, the terminal device receives the first indication information from the network device.

The first indication information may include the following two possible designs.

Design 1: The first indication information includes a first index, the first index corresponds to a first-type slot format, the first-type slot format indicates a transmission direction of a signal transmitted on each time domain symbol in one slot and a type of the signal transmitted on each time domain symbol, and the type includes the sensing signal or the communication signal.

In the foregoing design, the network device may directly indicate, to the terminal device, the transmission direction of the signal transmitted on each time domain symbol in the slot and the type of the transmitted signal.

For example, the network device and the terminal device negotiate with each other over a first-type slot format table shown in Table 8. For example, the first-type slot format table includes a plurality of indexes, the transmission direction of the signal transmitted on each time domain symbol in the slot corresponding to each index, and the type of the signal transmitted on each time domain symbol. The network device indicates, to the terminal device, one of the plurality of indexes. Downlink sensing (DS), downlink communication (DC), uplink sensing (US), uplink communication (UC), flexible sensing (FS), and flexible communication (FC) are predefined slot formats. Uplink sensing data may be sent during the US and the FS, downlink sensing data may be sent during the DS and the FS, uplink communication data may be sent during the UC and the FC, and downlink communication data may be sent during the DC and the FC.

TABLE 8

| | Slot format | | | | | | | | | | | | | |
|---|---|---|---|---|---|---|---|---|---|---|---|---|---|---|
| | 1 | 2 | 3 | 4 | 5 | 6 | 7 | 8 | 9 | 10 | 11 | 12 | 13 | 14 |
| 0 | US | DC | DC | DC | FC | FC | FC | FC | FC | UC | UC | UC | UC | UC |
| 1 | US | DS | DC | DC | DC | FC | FC | FC | FC | FC | UC | UC | UC | UC |

Design 2: The first indication information includes a second index and a third index, the second index corresponds to a second-type slot format, the second-type slot format indicates a transmission direction of a signal transmitted on each time domain symbol in one slot, the third index corresponds to a third-type slot format, the third-type slot format indicates a type of the signal transmitted on each time domain symbol in the slot, and the type includes the sensing signal or the communication signal.

In the foregoing design, the network device may separately indicate, to the terminal device, the transmission direction of the signal transmitted on each time domain symbol in the slot and the type of the signal transmitted on each time domain symbol in the slot. After receiving the indication information, the terminal device may determine to send an uplink sensing signal, a downlink sensing signal, an uplink communication signal, or a downlink communication signal on the time domain symbol.

For example, the network device and the terminal device negotiate with each other over the second-type slot format table shown in Table 9 and the third-type slot format table shown in Table 10. For example, the second-type slot format table includes a plurality of indexes and a transmission direction that is of a signal transmitted on each time domain symbol in a slot and that corresponds to each index. The network device indicates, to the terminal device, one of the plurality of indexes. Uplink data may be sent in U and F, and downlink data may be sent in D and F. The third-type slot format table includes a plurality of indexes and a type that is of a signal transmitted on each time domain symbol in a slot and that corresponds to each index. The network device indicates, to the terminal device, one of the plurality of indexes. Sensing data may be sent in S, and communication data may be sent in C. In other words, a table of a signal type (a combination of S and C) is added based on an existing slot format table (a combination of D, U, and F), and a type and a direction of a signal transmitted on each time domain symbol in one slot can be determined by multiplying the two tables.

TABLE 9

| | Slot format | | | | | | | | | | | | | |
|---|---|---|---|---|---|---|---|---|---|---|---|---|---|---|
| | 1 | 2 | 3 | 4 | 5 | 6 | 7 | 8 | 9 | 10 | 11 | 12 | 13 | 14 |
| 0 | D | D | D | D | D | D | D | D | D | D | D | D | D | D |
| 1 | U | U | U | U | U | U | U | U | U | U | U | U | U | U |

TABLE 10

| | Slot format | | | | | | | | | | | | | |
|---|---|---|---|---|---|---|---|---|---|---|---|---|---|---|
| | 1 | 2 | 3 | 4 | 5 | 6 | 7 | 8 | 9 | 10 | 11 | 12 | 13 | 14 |
| 0 | S | C | C | C | C | C | C | C | C | C | C | C | C | C |
| 1 | S | S | C | C | C | C | C | C | C | C | C | C | C | C |

For example, the second index indicated by the network device to the terminal device is 0, and the third index indicated by the network device to the terminal device is 0. Rows corresponding to indexes 0 in the two tables are combined to obtain DS, DC, DC, DC, DC, DC, DC, DC, DC, DC, DC, DC, DC and DC. In this way, the terminal device may determine the type and the direction of the signal transmitted on each time domain symbol in the slot.

It should be understood that Table 8 to Table 10 show an example of only two types of slot formats, for example, slot formats corresponding to the index 0 and an index 1. However, this should not constitute any limitation on this embodiment of this application. In another embodiment, more or fewer types of slot formats may be included. This is not limited in this embodiment of this application.

It should be further understood that indexes shown in Table 8 to Table 10 and slot formats corresponding to the indexes are not limited to being in a form of a table, and may alternatively be in another data structure, for example, an array, a queue, or a stack. The foregoing form is not specifically limited in this embodiment of this application.

Optionally, the first indication information may be carried in RRC or DCI.

In other words, the network device may add the index to the RRC or the DCI, so that the terminal device indicates a transmission direction and a type that are of a signal transmitted on each time domain symbol in one slot.

It may be understood that the network device may further indicate, to the terminal device by adding a field (for example, a sensing symbol indicator (sensing symbol indicator)) to the DCI or the RRC, whether the sensing signal can be sent on the time domain symbol. For example, a value of “0” in the newly added field indicates that the sensing signal cannot be sent on the time domain symbol, and a value of “1” in the newly added field indicates that the sensing signal can be sent on the time domain symbol.

Optionally, the network device may indicate, to the terminal device, the first numerology for the sensing signal and the second numerology for the communication signal.

For example, the network device sends second indication information to the terminal device, where the second indication information indicates the first numerology and the second numerology. Correspondingly, the terminal device receives the second indication information from the network device.

For example, the second indication information carries a fourth index, the fourth index indicates a numerology format, and the numerology format indicates a numerology corresponding to a signal transmitted on each time domain symbol in the slot.

Table 11 shows an example of configurations of two numerology formats. A numerology format corresponding to the index 0 is: an index of a numerology corresponding to a signal in a 1^{st} time domain symbol is 6, and indexes of numerologies corresponding to signals in other time domain symbols are all 1. A numerology format corresponding to the index 1 is: indexes of numerologies corresponding to signals in a 1^{st} time domain symbol and a 2^{nd} time domain symbol are 7, and indexes of numerologies corresponding to signals in other time domain symbols are all 1. For example, the network device may indicate the index 0 to the terminal device, and the terminal device determines, based on the numerology format corresponding to the index 0, the index of the numerology corresponding to the signal in each time domain symbol, and then queries the numerology table based on the index of the numerology, to determine a length of the time domain symbol.

TABLE 11

| | Numerology format | | | | | | | | | | | | | |
|---|---|---|---|---|---|---|---|---|---|---|---|---|---|---|
| | 1 | 2 | 3 | 4 | 5 | 6 | 7 | 8 | 9 | 10 | 11 | 12 | 13 | 14 |
| 0 | 6 | 1 | 1 | 1 | 1 | 1 | 1 | 1 | 1 | 1 | 1 | 1 | 1 | 1 |
| 1 | 7 | 7 | 1 | 1 | 1 | 1 | 1 | 1 | 1 | 1 | 1 | 1 | 1 | 1 |

It should be understood that Table 11 shows an example of only two types of numerology formats, for example, numerology formats corresponding to an index 0 and an index 1. However, this should not constitute any limitation on this embodiment of this application. In another embodiment, more or fewer types of numerology formats may be included. This is not limited in this embodiment of this application.

It should be further understood that the indexes and the numerology formats corresponding to the indexes shown in Table 11 are not limited to being in a form of a table, and may alternatively be in another data structure, for example, an array, a queue, or a stack. The foregoing form is not specifically limited in this embodiment of this application.

Optionally, the second indication information is carried in the RRC or the DCI.

For example, a sensing numerology indicator (SNI) field is added to the DCI, and the network device indicates the fourth index by using the SNI field in the DCI.

For another example, a new field “Sensing-ConfigCommon” is added to the RRC message, and the network device indicates, by using the field, a subcarrier spacing corresponding to the first time domain symbol for transmitting the sensing signal.

Optionally, the first apparatus is the terminal device, and the terminal device determines the numerology based on an indication of a latest received numerology.

For example, the terminal device receives a numerology format indicated by the network device, where the numerology format indicates that indexes of numerologies corresponding to time domain symbols in one slot are 1. Further, the terminal device receives the numerology format indicated by the network device, where the numerology format indicates that an index of a numerology corresponding to a 1^{st} time domain symbol in a slot is 6, and indexes of numerologies corresponding to remaining time domain symbols are 1. In this case, the terminal device sends or receives a signal based on a latest indicated numerology format (that is, the index of the numerology corresponding to the 1^{st} time domain symbol in the slot is 6, and the indexes of the numerologies corresponding to the remaining time domain symbols are 1).

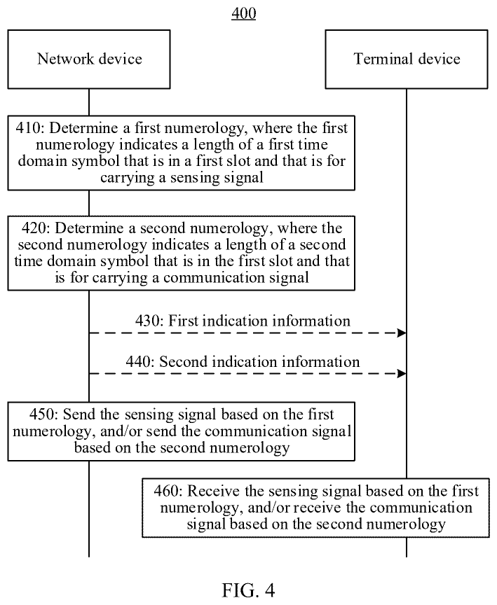

FIG. 4 is another schematic flowchart of a sensing signal transmission method according to an embodiment of this application. The method 400 shown in FIG. 4 may include step 410 to step 460. The following describes in detail the steps in the method 400.

It should be understood that the embodiment shown in FIG. 4 may be applied to a bistatic sensing scenario. An example in which a network device is used as a sending device of a sensing signal and a terminal device is used as a receiving device of the sensing signal is used for description.

Step 410: The network device determines a first numerology, where the first numerology indicates a length of a first time domain symbol that is in a first slot and that is for carrying the sensing signal.

The sensing signal is used for sensing a target, the first numerology indicates the length of the first time domain symbol that is in the first slot and that is for carrying the sensing signal, and the first slot is any slot. The length of the first time domain symbol neither includes a length of a GI nor includes a length of a CP corresponding to the first time domain symbol.

In a possible implementation, the network device may determine the first numerology based on a sensing range and a first mapping relationship, and the first mapping relationship indicates at least one correspondence between the first numerology and the sensing range. For example, the network device may first determine an expected sensing range, and determine, based on the first mapping relationship, the first numerology corresponding to the sensing range.

For more detailed descriptions of step 410, refer to step 310. Details are not described herein again.

Step 420: The network device determines a second numerology, where the second numerology indicates a length of a second time domain symbol that is in the first slot and that is for carrying a communication signal.

The communication signal is for communication, and the second numerology indicates the length of the second time domain symbol that is in the first slot and that is for carrying the communication signal. The length of the second time domain symbol does not include a length of a CP corresponding to the second time domain symbol.

For more detailed descriptions of step 420, refer to step 320. Details are not described herein again.

Step 430: The network device sends first indication information to the terminal device. Correspondingly, the terminal device receives the first indication information from the network device.

The first indication information indicates a transmission direction of the sensing signal and the first time domain symbol for transmitting the sensing signal.

For a possible design of the first indication information, refer to the foregoing description. Details are not described herein again.

Step 440: The network device sends second indication information to the terminal device. Correspondingly, the terminal device receives the second indication information from the network device.

The second indication information indicates the first numerology and the second numerology.

For a possible design of the second indication information, refer to the foregoing description. Details are not described herein again.

It may be understood that step 430 and step 440 are optional steps, and should not constitute any limitation on this embodiment of this application.

Step 450: The network device sends the sensing signal based on the first numerology, and/or sends the communication signal based on the second numerology.

It may be understood that although the network device determines the second numerology, the network device may not send nor receive the communication signal, or although the network device determines the first numerology, the network device may not send nor receive the sensing signal. This is not limited in this embodiment of this application.

Step 460: The terminal device receives the sensing signal based on the first numerology, and/or receives the communication signal based on the second numerology.

In a possible implementation, the terminal device may determine the first numerology and the second numerology based on the second indication information, and then receive the sensing signal based on the first numerology and/or receive the communication signal based on the second numerology on the time domain resource indicated by the first indication information.

In another possible implementation, the terminal device may determine, based on the sensing range and the mapping relationship between the sensing range and the index of the first numerology shown in Table 7, the index of the first numerology corresponding to the sensing range, and then determine the first numerology based on the index of the first numerology. The sensing range may be negotiated over by the network device and the terminal device.

It should be further understood that step 450 and step 460 show a scenario in which the network device sends the sensing signal and the terminal device receives the sensing signal. However, this should not constitute any limitation on this embodiment of this application. For example, in a scenario in which the terminal device sends the sensing signal and the network device receives the sensing signal, step 450 may be replaced with that the terminal device sends the sensing signal based on the first numerology, and/or sends the communication signal based on the second numerology, and step 460 may be replaced with that the network device receives the sensing signal based on the first numerology, and/or receives the communication signal based on the second numerology.

The following describes in detail different designs of a resource carrying the sensing signal in frequency domain with reference to specific examples.

As described above, in this application, two numerologies may be used in the first slot. In other words, the length of the first time domain symbol and the length of the second time domain symbol are different. For example, in a slot, a 1^{st} time domain symbol is the first time domain symbol, and a remaining time domain symbol is the second time domain symbol. For example, a subcarrier spacing corresponding to the second time domain symbol is 60 kHz, and a subcarrier spacing corresponding to the first time domain symbol is 480 kHz. After the 1^{st} time domain symbol is set to 480 kHz, a length of the 1^{st} time domain symbol is less than the length of the second time domain symbol. For example, the first time domain symbol and the second time domain symbol may be aligned by adding 0. In this case, from a perspective of frequency domain, the following designs may be used to allocate a frequency domain resource.

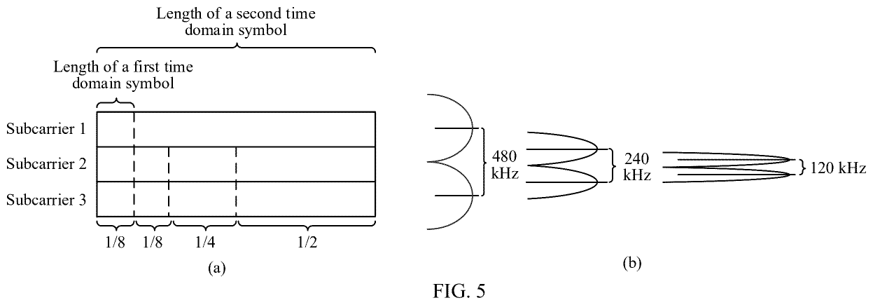

From the perspective of frequency domain, in a possible design, in the first time domain symbol, all frequency domain (or subcarriers) are for sensing. In another possible design, in the first time domain symbol, not all frequency domain (or subcarriers) is for sensing. As shown in (a) in FIG. 5, a subcarrier 1 is for sensing, and a subcarrier 2 and a subcarrier 3 are not necessarily for carrying the sensing signal, for example, for carrying the communication signal. A length of a time domain symbol for carrying the communication signal is eight times the length of the first time domain symbol. Therefore, the first apparatus may use a subcarrier spacing of 480 kHz for ⅛ of a length of a time domain symbol corresponding to the subcarrier 2 and the subcarrier 3, and the remaining ⅞ of the length of the time domain symbol may be designed as follows: The subcarrier spacing of 480 kHz may still be used for the remaining ⅛ of the length of the time domain symbol, a subcarrier spacing of 240 kHz may be used for ¼ of the length of the time domain symbol, and a subcarrier spacing of 120 kHz may be used for ½ of the length of the time domain symbol. In this way, the resources can be used more effectively. (b) in FIG. 5 shows waveforms of different subcarrier spacings, for example, a waveform corresponding to the subcarrier spacing of 480 kHz, a waveform corresponding to the subcarrier spacing of 240 kHz, and a waveform corresponding to the subcarrier spacing of 120 kHz.

Based on the foregoing technical solutions, the first apparatus may separately determine the first numerology indicating the length of the first time domain symbol carrying the sensing signal and the second numerology indicating the length of the second time domain symbol carrying the communication signal, and send or receive a corresponding signal based on a corresponding numerology. In other words, the first numerology for sensing and the second numerology for communication may be different. The first apparatus may flexibly adjust the first numerology for sensing without changing the second numerology for communication, so that transmission of the communication signal is not affected. This helps ensure compatibility between the sensing signal and the communication signal.

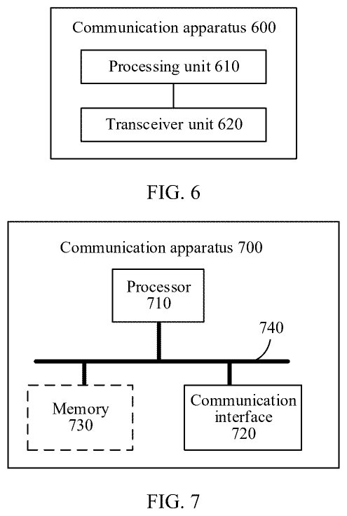

FIG. 6 to FIG. 9 are diagrams of structures of possible communication apparatuses according to embodiments of this application.

FIG. 6 is a block diagram of a communication apparatus 600 according to an embodiment of this application.

As shown in FIG. 6, the communication apparatus 600 includes a processing unit 610 and a transceiver unit 620.

The communication apparatus 600 may be configured to implement a function of the first apparatus in the foregoing method embodiments, or the communication apparatus 600 may include a module configured to implement any function or operation of the first apparatus in the foregoing method embodiments. The module may be all or partially implemented by using software, hardware, firmware, or any combination thereof.

For example, when the communication apparatus 600 is configured to implement the functions of the first apparatus (for example, the network device) in the method embodiment shown in FIG. 3, the processing unit 610 may be configured to: determine a first numerology, where the first numerology indicates a length of a first time domain symbol for carrying a sensing signal; and determine a second numerology, where the second numerology indicates a length of a second time domain symbol that is in a first slot and that is for carrying a communication signal, and the length of the first time domain symbol and the length of the second time domain symbol are in an integer multiple relationship. The transceiver unit 620 may be configured to perform at least one of the following: sending the sensing signal based on the first numerology; sending the communication signal based on the second numerology; receiving the sensing signal based on the first numerology; or receiving the communication signal based on the second numerology.

Optionally, the first numerology is determined based on a sensing range and a first mapping relationship, and the first mapping relationship indicates at least one correspondence between the first numerology and the sensing range.

Optionally, the length of the first time domain symbol is less than the length of the second time domain symbol.

Optionally, the processing unit 610 is further configured to determine a GI corresponding to the length of the first time domain symbol, where a resource in the GI is not for carrying a signal.

Optionally, a length of the GI+the length of the first time domain symbol=the length of the second time domain symbol; or a length of the GI+the length of the first time domain symbol=the length of the second time domain symbol+a length of a first cyclic prefix CP, where the first CP is a CP corresponding to the second time domain symbol.

Optionally, the length of the first time domain symbol is less than (R1+R2−d)/c, where R1 represents a shortest distance between a sending apparatus of the sensing signal and a target region sensed by the sensing signal, R2 represents a shortest distance between a receiving apparatus of the sensing signal and the target region, c represents a speed of light, and d is a distance between the sending apparatus and the receiving apparatus.

Optionally, a second CP is added before the first time domain symbol, and the second CP is a CP corresponding to the first time domain symbol.

Optionally, the apparatus is a network device, and the transceiver unit 620 is further configured to send first indication information, where the first indication information indicates a transmission direction of the sensing signal and the first time domain symbol for transmitting the sensing signal.

Optionally, the apparatus is a terminal device, and the transceiver unit 620 is further configured to receive first indication information, where the first indication information indicates a transmission direction of the sensing signal and the first time domain symbol for transmitting the sensing signal.

Optionally, the first indication information includes a first index, the first index corresponds to a first-type slot format, the first-type slot format indicates a transmission direction of a signal transmitted on each time domain symbol in one slot and a type of the signal transmitted on each time domain symbol, and the type includes the sensing signal or the communication signal.

Optionally, the first indication information includes a second index and a third index, the second index corresponds to a second-type slot format, the second-type slot format indicates a transmission direction of a signal transmitted on each time domain symbol in one slot, the third index corresponds to a third-type slot format, the third-type slot format indicates a type of the signal transmitted on each time domain symbol in the slot, and the type includes the sensing signal or the communication signal.

Optionally, the apparatus is the network device, and the transceiver unit 620 is further configured to send second indication information, where the second indication information indicates the first numerology and the second numerology.

Optionally, the apparatus is the terminal device, and the transceiver unit 620 is further configured to receive second indication information, where the second indication information indicates the first numerology and the second numerology.

Optionally, the second indication information is carried in an RRC message, or the second indication information is carried in DCI.

For more detailed descriptions of the processing unit 610 and the transceiver unit 620, directly refer to related descriptions in the foregoing method embodiments. Details are not described herein again.

It should be understood that in embodiments of this application, division into units is an example and is merely logical function division. During actual implementation, there may be another division manner. In addition, functional units in embodiments of this application may be integrated into one processor, or may exist alone physically, or two or more units are integrated into one unit. The integrated unit may be implemented in a form of hardware, or may be implemented in a form of a software functional unit.

FIG. 7 is another block diagram of a communication apparatus 700 according to an embodiment of this application. The communication apparatus 700 may be a chip system, or may be an apparatus configured with a chip system, to implement a communication function in the foregoing method embodiments. In this embodiment of this application, the chip system may include a chip, or may include a chip and another discrete device.

As shown in FIG. 7, the communication apparatus 700 may include a processor 710 and a communication interface 720. The communication interface 720 may be configured to communicate with another device by using a transmission medium, so that the communication apparatus 700 may communicate with the another device. The communication interface 720 may be, for example, a transceiver, an interface, a bus, a circuit, or an apparatus that can implement a transceiver function. The processor 710 may input and output data by using the communication interface 720, and is configured to implement the method in the embodiment corresponding to FIG. 3, or is configured to implement the method in the embodiment shown in FIG. 4.

When the communication apparatus 700 is configured to implement the method shown in FIG. 3, the processor 710 may be configured to: determine a first numerology, where the first numerology indicates a length of a first time domain symbol for carrying a sensing signal; determine a second numerology, where the second numerology indicates a length of a second time domain symbol that is in a first slot and that is for carrying a communication signal, and the length of the first time domain symbol and the length of the second time domain symbol are in an integer multiple relationship; and perform at least one of the following: sending the sensing signal based on the first numerology; sending the communication signal based on the second numerology; receiving the sensing signal based on the first numerology; or receiving the communication signal based on the second numerology.

Optionally, the communication apparatus 700 further includes at least one memory 730, configured to store program instructions and/or data. The memory 730 is coupled to the processor 710. The coupling in this embodiment of this application may be an indirect coupling or a communication connection between apparatuses, units, or modules in an electrical form, a mechanical form, or another form, and is used for information exchange between the apparatuses, the units, or the modules. The processor 710 may cooperate with the memory 730. The processor 710 may execute the program instructions stored in the memory 730. At least one of the at least one memory may be included in the processor.

In this embodiment of this application, a specific connection medium between the processor 710, the communication interface 720, and the memory 730 is not limited. In this embodiment of this application, in FIG. 7, the processor 710, the communication interface 720, and the memory 730 are connected through a bus 740. The bus 740 is represented by a thick line in FIG. 7. A manner of connection between other parts is merely an example for description, and is not limited thereto. Buses may be classified into an address bus, a data bus, a control bus, and the like. For ease of representation, only one thick line is used for representation in FIG. 7, but this does not mean that there is only one bus or only one type of bus.

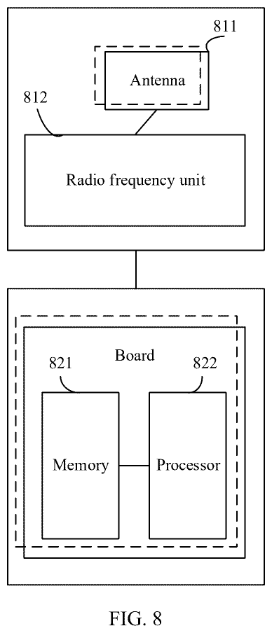

FIG. 8 is a diagram of a structure of a network device according to an embodiment of this application, for example, may be a diagram of a structure of a base station. The base station may perform a function of the network device. As shown in FIG. 8, the base station may include one or more transceiver units and one or more processing units. For example, the transceiver unit may be a remote radio unit (RRU), and the processing unit may be a baseband unit (BBU). Optionally, the transceiver unit may also be referred to as a transceiver machine, a transceiver circuit, a transceiver, or the like, and may include at least one antenna 811 and a radio frequency unit 812. Optionally, the transceiver unit may include a receiving unit and a sending unit. The receiving unit may correspond to a receiver (or referred to as a receiver machine or a receiver circuit), and the sending unit may correspond to a transmitter (or referred to as a transmitter machine or a transmitter circuit). The transceiver unit is mainly configured to receive and send a radio frequency signal and perform conversion between the radio frequency signal and a baseband signal, for example, configured to send configuration information to a terminal device. The processing unit is mainly configured to perform baseband processing, control the base station, and the like. The transceiver unit and the processing unit may be physically disposed together, or may be physically separated, that is, a distributed base station. In some possible implementations, the RRU may be replaced with an active antenna unit (AAU), and the RRU may implement a function of the RRU and some functions of the BBU.

The processing unit is a control center of the base station, and is mainly configured to implement a baseband processing function, for example, channel coding, multiplexing, modulation, and spectrum spreading. For example, the processing unit may be configured to control the base station to perform an operation procedure related to the network device in the foregoing method embodiments. The processing unit may also be implemented as a CU and a DU.

In an example, the processing unit may include one or more boards. The plurality of boards may jointly support a radio access network (such as an LTE network) of a single access standard, or may separately support radio access networks (such as an LTE network, a 5G network, or another network) of different access standards. The processing unit further includes a memory 821 and a processor 822. The memory 821 is configured to store necessary instructions and data. The processor 822 is configured to control the base station to perform a necessary action, for example, configured to control the base station to perform an operation procedure related to the network device in the foregoing method embodiments. The memory 821 and the processor 822 may serve the one or more boards. In other words, the memory and the processor may be separately disposed on each board. Alternatively, a plurality of boards may share a same memory and a same processor. In addition, a necessary circuit may further be disposed on each board.

It should be understood that the base station shown in FIG. 8 can implement processes of the network device in the foregoing method embodiments. Operations and/or functions of the modules in the base station are respectively intended to implement corresponding procedures in the foregoing method embodiments. For details, refer to the descriptions in the foregoing method embodiments. To avoid repetition, detailed descriptions are properly omitted herein.

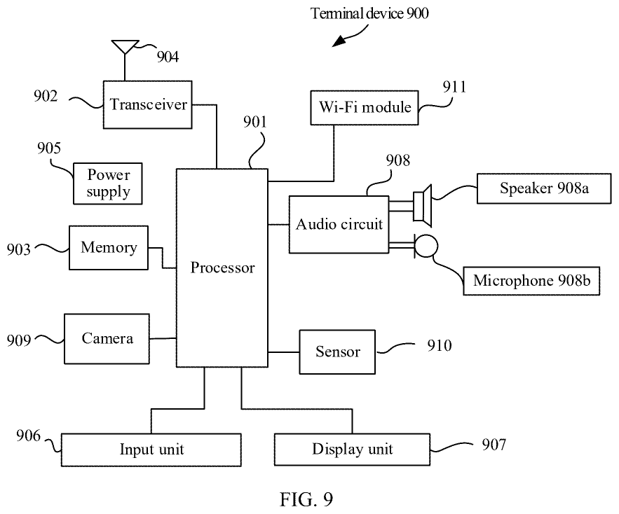

FIG. 9 is a diagram of a structure of a terminal device according to an embodiment of this application. The terminal device 900 has, for example, functions of the first apparatus. As shown in FIG. 9, the terminal device 900 includes a processor 901 and a transceiver 902.

Optionally, the terminal device 900 further includes a memory 903. The processor 901, the transceiver 902, and the memory 903 may communicate with each other through an internal connection path, to transmit a control signal and/or a data signal. The memory 903 is configured to store a computer program. The processor 901 is configured to invoke the computer program from the memory 903 and run the computer program, to control the transceiver 902 to receive or send a signal. Optionally, the terminal device 900 may further include an antenna 904, configured to send, by using a radio signal, uplink data or uplink control signaling output by the transceiver 902. Optionally, the terminal device 900 further includes a Wi-Fi module 911, configured to access a wireless network.

The processor 901 and the memory 903 may be integrated into one processing apparatus. The processor 901 is configured to execute program code stored in the memory 903 to implement the foregoing functions. During specific implementation, the memory 903 may alternatively be integrated into the processor 901, or may be independent of the processor 901. The processor 901 may correspond to the processing unit 610 in FIG. 6 or the processor 710 in FIG. 7.

The transceiver 902 may correspond to the transceiver unit 620 in FIG. 6, or correspond to the communication interface 720 in FIG. 7. The transceiver 902 may include a receiver (or referred to as a receiver machine or a receiver circuit) and a transmitter (or referred to as a transmitter machine or a transmitter circuit). The receiver is configured to receive a signal, and the transmitter is configured to transmit a signal.

Optionally, the terminal device 900 may further include a power supply 905, configured to supply power to various devices or circuits in the terminal device 900.

In addition, to improve functions of the terminal device, the terminal device 900 may further include one or more of an input unit 906, a display unit 907, an audio circuit 908, a camera 909, a sensor 910, and the like. The audio circuit may further include a speaker 908a, a microphone 908b, and the like.

It should be understood that the terminal device 900 shown in FIG. 9 can implement processes related to the terminal device in the method embodiment shown in FIG. 3, or implement processes related to the terminal device in the method embodiment shown in FIG. 4. The operations and/or functions of the modules in the terminal device 900 are respectively intended to implement corresponding procedures in the foregoing method embodiments. For details, refer to the descriptions in the foregoing method embodiments. To avoid repetition, detailed descriptions are properly omitted herein.

This application further provides a computer program product. The computer program product includes a computer program (which may also be referred to as code or instructions). When the computer program is run, a computer is enabled to perform the method in FIG. 3 or FIG. 4.

This application further provides a computer-readable storage medium. The computer-readable storage medium stores a computer program (which may also be referred to as code or instructions). When the computer program is run, a computer is enabled to perform the method in FIG. 3 or FIG. 4.

This application further provides a communication system, including a terminal device and a network device.

It should be noted that the processor in embodiments of this application may be an integrated circuit chip, and has a signal processing capability. In an implementation process, steps in the foregoing method embodiments can be implemented by using an integrated logic circuit of hardware in the processor, or by using instructions in a form of software. The foregoing processor may be a general-purpose processor, a digital signal processor (DSP), an application-specific integrated circuit (ASIC), a field programmable gate array (FPGA) or another programmable logic device, a discrete gate or a transistor logic device, or a discrete hardware component. The processor may implement or perform the methods, the steps, and the logical block diagrams that are disclosed in embodiments of this application. The general-purpose processor may be a microprocessor, or the processor may be any conventional processor or the like. The steps in the methods disclosed with reference to embodiments of this application may be directly performed and completed by a hardware decoding processor, or may be performed and completed by using a combination of hardware and a software module in the decoding processor. The software module may be located in a mature storage medium in the art, such as a random access memory, a flash memory, a read-only memory, a programmable read-only memory, an electrically erasable programmable memory, or a register. The storage medium is located in the memory, and the processor reads information in the memory and completes the steps in the foregoing methods in combination with hardware of the processor.

It may be understood that the memory in embodiments of this application may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM) and is used as an external cache. By way of example, but not limitation, many forms of RAMs may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM). It should be noted that the memory in the systems and methods described in this specification is intended to include but is not limited to these memories and any memory of another appropriate type.

Terms such as “unit” and “module” used in this specification may indicate computer-related entities, hardware, firmware, combinations of hardware and software, software, or software being executed. The units and the modules in embodiments of this application have a same meaning, and may be used in a cross manner.

A person of ordinary skill in the art may be aware that, in combination with illustrative logical blocks and steps described in embodiments disclosed in this specification, the illustrative logical blocks and steps may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application. In several embodiments provided in this application, it should be understood that the disclosed apparatuses, devices, and methods may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, in other words, may be located in one position, or may be distributed on a plurality of network units. Some or all of the units may be selected based on actual requirements to achieve the objectives of the solutions of embodiments.

In addition, functional units in embodiments of this application may be integrated into one processing unit, or each of the units may exist alone physically, or two or more units are integrated into one unit.

In the foregoing embodiments, all or some of the functions of the functional units may be implemented by using software, hardware, firmware, or any combination thereof. When software is used to implement embodiments, all or a part of embodiments may be implemented in a form of a computer program product. The computer program product includes one or more computer instructions (programs). When the computer program instructions (programs) are loaded and executed on the computer, the procedures or functions according to embodiments of this application are all or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), or a semiconductor medium (for example, a solid-state drive (SSD)), or the like.

When the functions provided in embodiments of this application are implemented in a form of a software functional unit and sold or used as an independent product, the functions may be stored in a computer-readable storage medium. Based on such an understanding, the technical solutions of this application essentially, or the part contributing to the conventional technology, or some of the technical solutions may be implemented in a form of a software product. The computer software product is stored in a storage medium and includes several instructions for instructing a computer device (which may be a personal computer, a server, a network device, or the like) to perform all or a part of the steps of the methods described in embodiments of this application. The foregoing storage medium includes any medium that can store program code, such as a USB flash drive, a removable hard disk, a ROM, a RAM, a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A sensing signal transmission method, comprising:
determining, by a first apparatus, a first numerology, wherein the first numerology indicates a length of a first time domain symbol that is in a first slot and that is for carrying a sensing signal;
determining, by the first apparatus, a second numerology, wherein the second numerology indicates a length of a second time domain symbol that is in the first slot and that is for carrying a communication signal, and the length of the first time domain symbol and the length of the second time domain symbol are in an integer multiple relationship; and
performing, by the first apparatus, at least one of the following:
sending the sensing signal based on the first numerology;
sending the communication signal based on the second numerology;
receiving the sensing signal based on the first numerology; or
receiving the communication signal based on the second numerology.

2. The method according to claim 1, wherein the first numerology is determined based on a sensing range and a first mapping relationship, and the first mapping relationship indicates at least one correspondence between the first numerology and the sensing range.

3. The method according to claim 1, wherein the length of the first time domain symbol is less than the length of the second time domain symbol.

4. The method according to claim 3, wherein the method further comprises:
determining, by the first apparatus, a guard interval (GI) corresponding to the length of the first time domain symbol, wherein a resource in the GI is not for carrying a signal.

5. The method according to claim 4, wherein:
a length of the GI+the length of the first time domain symbol=the length of the second time domain symbol; or
a length of the GI+the length of the first time domain symbol=the length of the second time domain symbol+a length of a first cyclic prefix (CP), wherein the first CP is a CP corresponding to the second time domain symbol.

6. The method according to claim 1, wherein the length of the first time domain symbol is less than (R1+R2−d)/c, R1 represents a shortest distance between a sending apparatus of the sensing signal and a target region sensed by the sensing signal, R2 represents a shortest distance between a receiving apparatus of the sensing signal and the target region, c represents a speed of light, and d is a distance between the sending apparatus and the receiving apparatus.

7. The method according to claim 1, wherein a second CP is added before the first time domain symbol, and the second CP is a CP corresponding to the first time domain symbol.

8. The method according to claim 1, wherein the first apparatus is a network device, and the method further comprises:
sending first indication information, wherein the first indication information indicates a transmission direction of the sensing signal and the first time domain symbol for transmitting the sensing signal.

9. The method according to claim 1, wherein the first apparatus is a terminal device, and the method further comprises:
receiving first indication information, wherein the first indication information indicates a transmission direction of the sensing signal and the first time domain symbol for transmitting the sensing signal.

10. A communication apparatus, comprising:
at least one processor; and
one or more memories coupled to the at least one processor and storing programming instructions for execution by the at least one processor to:
determine a first numerology, wherein the first numerology indicates a length of a first time domain symbol that is in a first slot and that is for carrying a sensing signal; and
determine a second numerology, wherein the second numerology indicates a length of a second time domain symbol that is in the first slot and that is for carrying a communication signal, and the length of the first time domain symbol and the length of the second time domain symbol are in an integer multiple relationship; and
perform at least one of the following:
sending the sensing signal based on the first numerology;
sending the communication signal based on the second numerology;
receiving the sensing signal based on the first numerology; or
receiving the communication signal based on the second numerology.

11. The apparatus according to claim 10, wherein the first numerology is determined based on a sensing range and a first mapping relationship, and the first mapping relationship indicates at least one correspondence between the first numerology and the sensing range.

12. The apparatus according to claim 10, wherein the length of the first time domain symbol is less than the length of the second time domain symbol.

13. The apparatus according to claim 12, wherein the programming instructions are for execution by the at least one processor to:
determine a guard interval (GI) corresponding to the length of the first time domain symbol, wherein a resource in the GI is not for carrying a signal.

14. The apparatus according to claim 13, wherein:
a length of the GI+the length of the first time domain symbol=the length of the second time domain symbol; or
a length of the GI+the length of the first time domain symbol=the length of the second time domain symbol+a length of a first cyclic prefix CP, wherein the first CP is a CP corresponding to the second time domain symbol.

15. The apparatus according to claim 10, wherein the length of the first time domain symbol is less than (R1+R2−d)/c, R1 represents a shortest distance between a sending apparatus of the sensing signal and a target region sensed by the sensing signal, R2 represents a shortest distance between a receiving apparatus of the sensing signal and the target region, c represents a speed of light, and d is a distance between the sending apparatus and the receiving apparatus.

16. The apparatus according to claim 10, wherein a second CP is added before the first time domain symbol, and the second CP is a CP corresponding to the first time domain symbol.

17. The apparatus according to claim 10, wherein the apparatus is a network device, and the programming instructions are for execution by the at least one processor to:
send first indication information, wherein the first indication information indicates a transmission direction of the sensing signal and the first time domain symbol for transmitting the sensing signal.

18. The apparatus according to claim 10, wherein the apparatus is a terminal device, and the programming instructions are for execution by the at least one processor to:
receive first indication information, wherein the first indication information indicates a transmission direction of the sensing signal and the first time domain symbol for transmitting the sensing signal.

19. The apparatus according to claim 10, wherein the programming instructions are for execution by the at least one processor to send or receive first indication information, wherein the first indication information comprises a first index, the first index corresponds to a first-type slot format, the first-type slot format indicates a transmission direction of a signal transmitted on each time domain symbol in one slot and a type of the signal transmitted on each time domain symbol, and the type comprises the sensing signal or the communication signal.

20. A non-transitory computer-readable storage medium, comprising executable instructions, wherein the executable instructions, when executed by a computer, cause the computer to:
determine a first numerology, wherein the first numerology indicates a length of a first time domain symbol that is in a first slot and that is for carrying a sensing signal;
determine a second numerology, wherein the second numerology indicates a length of a second time domain symbol that is in the first slot and that is for carrying a communication signal, and the length of the first time domain symbol and the length of the second time domain symbol are in an integer multiple relationship; and
perform at least one of the following:
sending the sensing signal based on the first numerology;
sending the communication signal based on the second numerology;
receiving the sensing signal based on the first numerology; or
receiving the communication signal based on the second numerology.
